(19) United States
(12) Patent Application Publication
(10) Pub. No.: US 2005/0058805 A1
(43) Pub. Date: Mar. 17, 2005

(54) Polymer composite molded body and method for producing the same

(76) Inventors: Toru Kimura, Funabashi-shi (JP); Naoyuki Shimoyama, Saitama-shi (JP); Masayuki Tobita, Isesaki-shi (JP)

Correspondence Address: FISH & RICHARDSON PC, 225 FRANKLIN ST, BOSTON, MA, 02110, US

(21) Appl. No.: 10/664,988

(22) Filed: Sep. 17, 2003

(51) Int. Cl. B32B 5/02; B32B 3/00; B32B 9/00

(52) U.S. Cl. 428/113; 442/59; 442/269; 442/366; 442/381; 264/405; 264/479; 428/297.4

(57) ABSTRACT

A polymer composite molded body contains a fiber and at least one sheet of fiber cloth in a polymer matrix. The fiber cloth is disposed in the polymer composite molded body along a surface thereof. A polymer composition containing the fiber and polymer matrix is impregnated into the fiber cloth. Then a magnetic field is applied to the polymer composition to orient the fibers in the composition in a direction crossing with the fiber cloth. Then the polymer composition is solidified to obtain the polymer composite molded body.

### BACKGROUND OF THE INVENTION

The present invention relates to a polymer composite molded body in which fibers are compounded into a polymer matrix and a method for producing the same. More particularly, it directs to a polymer composite molded body in which at least one sheet of a fiber cloth is disposed in a direction along a surface of the polymer composite molded body and fibers are oriented in a direction, preferably perpendicularly, crossing with the fiber cloth.

Currently, polymer composite molded bodies are generally known in the art, in which fibers such as glass fibers, carbon fibers, metal fibers, aramid fibers, and polybenzazole fibers are compounded into a polymer material as a matrix. Polymer composite molded bodies made by curing a prepreg or a stack thereof are also known. The prepreg is formed by impregnating a fabric of long fibers such as carbon fibers or glass fibers or fibers oriented in a direction with a polymer material. For example, a fiber-reinforced resin or rubber, which is enhanced in properties such as a coefficient of elasticity or mechanical strength, is widely used for various applications in a space engineering, an aircraft, an automobile, electrical equipment, or sport and leisure goods industries.

In a plate-like polymer composite molded body formed by curing a prepreg or a stack thereof, wherein the prepreg is formed by impregnating a fiber fabric(s) with a polymer material, fibers of the fabric extending in a direction parallel to the surface of the polymer composite molded body can improve mechanical properties such as coefficient of elasticity or strength, and thermal properties such as thermal expansion coefficient or thermal conductivity, in the direction parallel to the surface. In these materials, however, the mechanical or thermal properties cannot be improved in a direction perpendicular to the surface of the polymer composite molded body, namely a thickness direction of the polymer composite molded body.

For recent complex mechanical parts, it is demanded to materialize a novel polymer composite molded body having improved performance in mechanical properties such as a coefficient of elasticity or strength, thermal properties such as thermal expansion coefficient or thermal conductivity, as well as optical properties and electrical properties not only in the direction along the surface of the polymer composite molded body but also in the direction perpendicular to the surface of the polymer composite molded body.

Relating to a method for producing the polymer composite molded body in which the fibers are oriented in both directions, parallel to and perpendicular to the surface of the polymer composite molded body, Japanese Laid-open Patent Publication No. 6-339997 discloses a method for producing a fiber-reinforced plastic panel using a fabric in which fibers are woven three-dimensionally in the direction parallel to the surface of the fabric and the direction perpendicular to the surface. Japanese Laid-open Patent Publication No. 9-207236 discloses a highly impregnated three-dimensional fabric, a carbon fiber-reinforced composite material, and a ceramic composite material using the fabric. Some of these materials actually have been used.

However, the fibers disclosed above publications require a high precise production apparatus, which may increase the manufacturing cost. In addition, when the polymer composite molded body is formed by impregnating the fabric with a polymer material, in which fibers are previously woven three-dimensionally, some voids are generated between the fabric and the polymer material. This problem requires further modification in the production apparatus, causing some drawbacks in productivity and in manufacturing cost.

Therefore, more practical polymer composite molded body are needed, which have improved some properties in three-dimensional direction and which can be produced by a simplified method without any voids in the polymer composite molded body.

Accordingly, the objective of the present invention is to provide a polymer composite molded body in which fibers and at least one sheet of a fiber cloth are compounded into a polymer material, wherein the fibers are oriented in a direction crossing with each fiber cloth to improve some properties of the polymer composite molded body in three-dimensional directions, and a method for producing the same.

### BRIEF SUMMARY OF THE INVENTION

The present invention provides a polymer composite molded body having a surface, comprising a polymer matrix, at least one sheet of a fiber cloth disposed in the polymer matrix, wherein the fiber cloth is oriented along the surface of the polymer composite molded body, and fibers disposed in the polymer matrix. The fibers are oriented in a direction crossing with the fiber cloth.

The present invention also provides a method for producing a polymer composite molded body having a surface and containing a fiber and at least one sheet of a fiber cloth in a polymer matrix. The method comprises steps of preparing a molding die having a cavity with a shape corresponding to the polymer composite molded body to be produced; disposing the fiber cloth in the cavity such that the fiber cloth is aligned along the surface of the polymer composite molded body; filling the cavity with a polymer composition containing the fibers and the polymer matrix, thereby impregnating the polymer composition into each fiber cloth; applying a magnetic field to the polymer composition impregnated in the fiber cloth to orient the fibers in the polymer composition such that the fibers cross with the fiber cloth; and solidifying the polymer composition with the fibers being oriented therein.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWINGS

The invention, together with objects and advantages thereof, may best be understood by reference to the following description of the presently preferred embodiments together with the accompanying drawings in which:

FIGS. 1A and 1B are a perspective view and a cross-sectional view of a polymer composite molded body according to the present invention.

FIGS. 2A to 2C are a perspective view and a cross-sectional view showing a method for producing a polymer composite molded body according to the present invention.

FIG. 3 is an electron microscopic photograph presenting a cross-section of a polymer composite molded body according to the present invention.

### DETAILED DESCRIPTION OF THE PREFERRED EMBODIMENTS

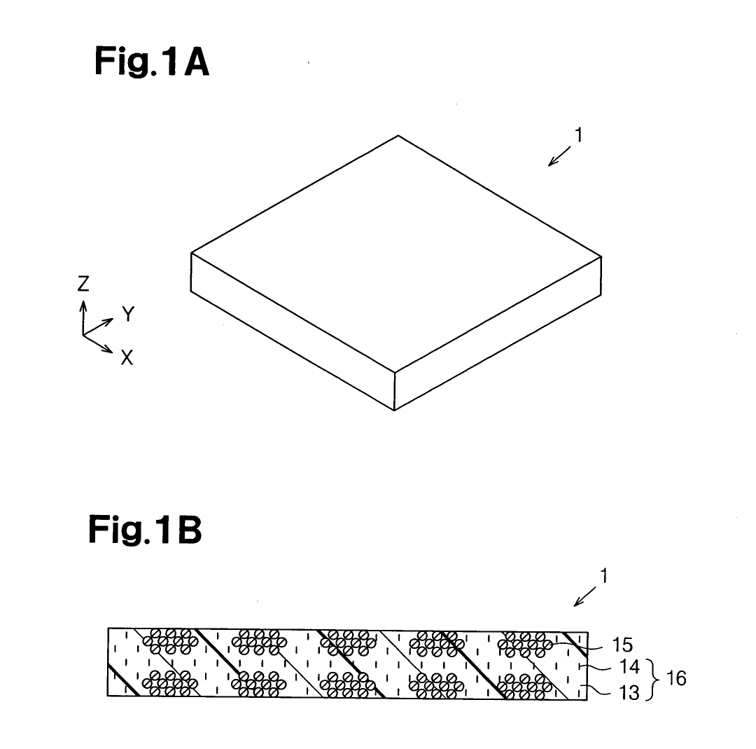

FIGS. 1A and 1B show polymer composite molded body 1 in a plate like form as one embodiment according to the present invention. As shown in FIG. 1B, a polymer composite molded body 1 comprises in a polymer matrix 13, a fiber 14, and at least one sheet (two sheets in FIG. 1B) of fiber cloth 15 that is formed by processing fibers into a cloth. In the polymer composite molded body 1, each fiber cloth 15 is disposed in a direction along at least one surface of the polymer composite molded body 1, for example, parallel to a top surface of the polymer composite molded body 1, as shown in FIGS. 1A and 1B (defined by arrows X and Y in 1A). The fibers 14 in the polymer composite molded body 1 are oriented in a direction crossing with the fiber cloth 15, for example, a thickness direction of the polymer composite molded body 1 as shown arrow Z in FIG. 1A. Preferably, the fibers 14 and the fiber cloths 15 are disposed in the polymer composite molded body 1 perpendicular to each other. The fibers 14 are compounded into the polymer matrix 13 to prepare a polymer composition 16. The polymer composition 16 is impregnated into the fiber cloths 15, and then the fibers 14 are oriented in a predetermined direction by a magnetic field force to obtain the polymer composite molded body 1. In the obtained polymer composite molded body 1, each fiber cloth extends in the direction along the surface of the polymer composite molded body 1, while the fibers 14 extend in the direction substantially perpendicular to the fiber cloths 15, improving the mechanical and thermal properties of the polymer composite molded body 1 in those three-dimensional directions.

The fiber 14 used for the polymer composite molded body 1 of the present invention includes carbon fibers, glass fibers, metal fibers, ceramic fibers, and organic fibers. As examples of carbon fibers, there are pitch type or PAN type carbon fibers. As the metal fibers, it is preferable to use metal fibers made of metals other than ferromagnetic metals, for example, diamagnetic SUS fibers. As the ceramic fibers, for example, fibers or whiskers comprising aluminum oxides, titanium oxides, silicon nitride, silicon carbide, aluminum borate, and potassium titanate can be used. As the organic fibers, for example, aramid fibers, polybenzazole fibers, polyethylene fibers, aliphatic polyamide fibers, polyimide fibers, polyphenylensulfide fibers, phenol fibers, polyolefin fibers, and vinylon fibers can be used.

The fiber 14, which is compounded into polymer matrix 13 to form the polymer composition 16, is not limited in its length or diameter. However, the length of the fiber 14 is preferably 10 mm or less, more preferably 5 mm or less, yet more preferably 2 mm or less with taking account of fluidity of the polymer composition 16 and workability when the polymer composition 16 is impregnated into the fiber cloth 15. The diameter of the fiber 14 is preferably 0.1 to 30 μm. In order to enhance the properties in the predetermined direction, a large aspect ratio (fiber length/fiber diameter) of the fiber 14 is preferably in general. However, if the length of the fiber 14 is longer than 10 mm, the fiber 14 cannot be dispersed uniformly in the polymer composition 16, which increases the viscosity of the polymer composition 16, resulting in a poor moldability of the composition 16. In addition, the longer fibers tend to get tangled each other, preventing the fibers from orienting in a direction. Although the lower limit of the fiber length may be varied depending on the fiber diameter and is not particularly specified, the fiber length is preferably 10 μm or more, more preferably 50 μm or more. When the fiber length is less than 10 μm, the aspect ratio may be less than 100 even if the fiber diameter is 0.1 μm, accordingly, it is difficult to obtain an enhancement effect for the mechanical or thermal properties of the polymer composite molded body 1 by orienting the fibers in a direction. A cross-sectional shape of the fiber 14 may be circle, oval, polygon, or other complex shapes.

The fiber 14 preferably has an anisotropic diamagnetic susceptibility χₐ of 1×10⁻⁹ emu/g or more, since the fiber 14 is oriented within the polymer composition 16 in a direction by a magnetic field force. If the anisotropic diamagnetic susceptibility χₐ of the fiber 14 is less than 1×10⁻⁹ emu/g, it is difficult to orient the fiber 14 in a direction by the magnetic force. The anisotropic diamagnetic susceptibility χₐ of the fiber 14 is more preferably 5×10⁻⁹ emu/g or more, yet more preferably 1×10⁻⁸ emu/g or more. The larger value of the anisotropic diamagnetic susceptibility χₐ allows the fiber 14 to be highly oriented in a direction by a magnetic field.

An anisotropic diamagnetic susceptibility χₐ is defined by the following equation (1), and presents a value indicating an anisotropic degree of the diamagnetic susceptibility of the fiber (CGS unit system).
χₐ=//−χ_{⊥}. (1)
wherein χ// represents a magnetic susceptibility of the fiber in the fiber axis when an external magnetic field is applied, and χ_{⊥}represents a magnetic susceptibility of the fiber in the direction perpendicular to the fiber axis when an external magnetic field is applied.

The fibers having a positive value as χₐ, such as carbon fibers, aramid fibers, and polybenzazole fibers, can be oriented such that their fiber axes are aligned parallel to the magnetic force line under the magnetic field atmosphere. The larger absolute value of the χₐ of the fiber is, the more accurately the fiber is oriented in a single direction by the magnetic field. On the other hand, when the fibers having a negative value as χₐ, such as polyethylene fibers, are subjected to the magnetic field, the magnetic field acts on the fibers such that their fiber axes are aligned perpendicular to the magnetic force line. As a result, the fibers will be oriented in the direction perpendicular to the magnetic line, namely in any directions on a plane perpendicular to the magnetic line. Accordingly, such fibers cannot be oriented in one direction. The anisotropic diamagnetic susceptibility χₐ may be measured by any traditional means including a magnetic anisotropic torque meter, a vibrating sample magnetometer, SQUID (Superconducting Quantum Interference Devices), a suspension method.

The fiber cloth 15 used for the polymer composite molded body of the present invention may be a woven or non-woven fabric comprising at least one fiber selected from carbon fibers, glass fibers, metal fibers, ceramic fibers, and organic fibers as above mentioned. The fiber cloth consisting of a woven fabric is typically produced by weaving fibers with spinning and weaving machines. The fiber cloth consisting of a non-woven fabric is typically produced by compressing the fibers. Furthermore, woven or non-woven fabrics impregnated with polymer materials also can be used for the fiber cloth 15.

Fiber diameter or weaving density of the fibers used for the fiber cloth 15 is not particularly specified. The preferred fiber diameter, however, may be 0.1 to 30 μm, and the preferred weaving density may be 5 to 50 yarns/25 mm in both of warps and wefts for practical use, with taking into account the productivity or handling of the fibers and the impregnation with polymer materials. Each woven fiber of the fiber cloth 15 may be separated enough from the adjacent fibers, and the number of warps and wefts in a unit area may be adjusted in order to facilitate to impregnate the fiber cloth 15 with the polymer composition 16 containing the fiber 14.

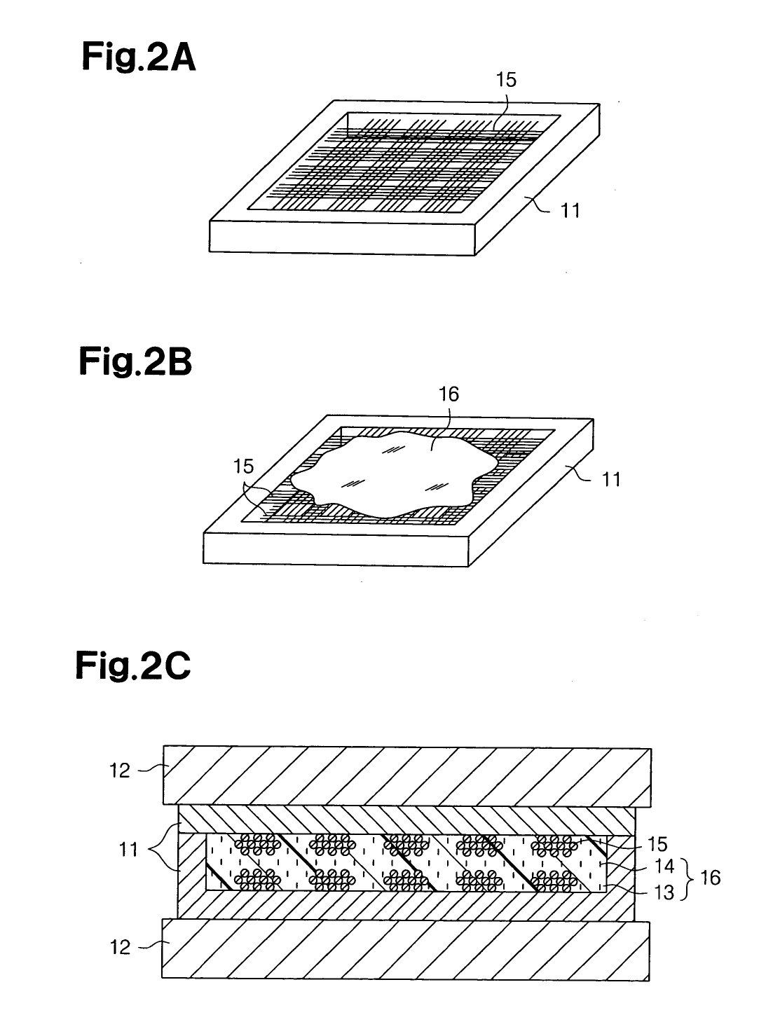

The method for disposing the fiber cloth 15 above mentioned in the direction along the surface of the polymer composite molded body 1 is not particularly limited. Any means for fixing the fiber cloth 15 within a cavity of a molding die 11, as shown in FIGS. 2A to 2C, may be provided for molding the polymer composite molded body 1. Preferably, the fiber cloth may be fixed in the cavity of the molding die 11 by a fixing means such as pins to prevent the fiber cloth 15 from moving even if the polymer composition 16 fluids within the cavity of the molding die 11 during molding.

The polymer matrix 13 is not particularly specified. For example, thermoplastic resins, thermoplastic elastomers, various curable resins, crosslinkable rubbers can be used as the polymer matrix 13 depending on the required performance for the desired polymer composite molded body 1 such as mechanical, thermal, or optical properties, durability, or reliability.

The thermoplastic resin includes polyethylene, polypropylene, ethylene-α-olefin copolymers such as ethylene-propylene copolymers, polymethylpentene, polyvinyl chloride, polyvinylidene chloride, polyvinyl acetate, ethylene vinyl acetate copolymers, polyvinyl alcohol, polyvinylacetal, fluororesins such as polyvinylidene fluoride and polytetrafluoroethylene, polyethylene terephthalate, polybutylene terephthalate, polyethylene naphthalate, polystyrene, polyacrylonitrile, styrene-acrylonitrile copolymers, ABS resins, polyphenylene ether (PPE) resins and modified PPE resins, aliphatic and aromatic polyamides, polyimides, polyamide imides, polymethacrylic acid and poly(arylene sulfide methacrylates) such as methyl arylene esters of polymethacrylic acid, polyacrylic acids, polycarbonate, polyphenylene sulfide, polysulfone, polyether sulfone, polyether nitrile, polyether ketone, polyketone, liquid crystal polymers, silicone resins, and ionomers.

The thermoplastic elastomer includes styrene-butadiene or styrene-isoprene block copolymers and hydrogenated polymers thereof, styrenic thermoplastic elastomers, olefinic thermoplastic elastomers, vinyl chloride thermoplastic elastomers, polyester thermoplastic elastomers, polyurethane thermoplastic elastomers, and polyamide thermoplastic elastomers.

The curable resin includes epoxy resin, polyimide resin, acrylic resin, bis-maleimide resin, benzocyclobutene resin, phenol resin, unsaturated polyester resin, diallyl phthalate resin, silicone resin, polyurethane resin, polyimide silicone resin, thermosetting polyphenylene ether resin, and modified PPE resin.

The cross-linkable rubber includes natural rubber, butadiene rubber, isoprene rubber, styrene-butadiene copolymer rubber, nitrile rubber, hydrogenated nitrile rubber, chloroprene rubber, ethylene-propylene rubber, chlorinated polyethylene, chlorosulfonated polyethylene, butyl rubber and halogenated butyl rubber, fluorine rubber, urethane rubber, silicone rubber, and liquid rubber.

In terms of temperature characteristics such as thermal resistance and electric reliability, the polymer matrix may be preferably at least one polymer material selected from the group consisting of epoxy resin, unsaturated polyester resin, phenol resin, acrylic resin, urethane resin, polyimide resin, silicone resin, and liquid rubbers. In addition, since these materials may be low viscosity liquid when the fiber 14 is mixed therein, or may become low viscosity liquid when it is heated and melted for molding, use of these materials as the polymer matrix 13 facilitates to control the orientation of the fibers 15 in the polymer matrix 13. More particularly, it is suitable to use polymer precursors or polymer materials having a low viscosity in its molten state, such as liquid epoxy resin or unsaturated polyester resin, liquid rubbers for the polymer matrix 13.

The polymer materials above mentioned may be used alone or in combination of two or more thereof. Polymer alloys also can be used comprising a plurality of the polymer materials selected from the above listed materials. A method for solidifying the curable resins or the cross-linkable rubbers is not particularly specified, and may be any conventional cross-linking methods, including thermosetting, photocuring, wet curing, and by radiating a radial ray or an electron beam.

The polymer composite molded body 1 of the present invention is characterized in that at least one sheet of the fiber cloth 15 as described above is disposed in the polymer composite molded body 1 in the direction along at least one surface of the polymer composite molded body 1 and the fibers 14 are oriented such that the fiber axes of the fibers 14 are aligned in the direction, preferably substantially perpendicularly, crossing the fiber cloth 15. Such arrangement of the fibers 14 and the fiber cloth 15 perpendicular to each other in the polymer composite molded body 1 allows the polymer composite molded body 1 to three-dimensionally exhibit various excellent properties due to such properties in the fiber axis direction of the fiber 14 and the fiber cloth 15, such as better coefficient of elasticity or mechanical strength.

In particularly, high tensile rupture strength of the carbon fibers or polybenzazole fibers in their fiber axes directions can improve the strength of the polymer composite molded body 1 in each direction that their fiber axes are oriented therein, when these fibers are compounded within the polymer composite molded body 1. Also, high coefficient of elasticity of the carbon fibers or polybenzazole fibers in their fiber axes directions can improve the coefficient of elasticity of the polymer composite molded body 1 in certain direction. Furthermore, low coefficient of thermal expansion of the carbon fibers or polybenzazole fibers in their fiber axes directions can reduce the coefficient of thermal expansion of the polymer composite molded body 1 or variation of dimensions of the polymer composite molded body 1 due to heat. The concentration or density of the fibers 14 and the fiber cloths 15 in the polymer composite 1 can be adjusted such that above properties are consistent in all directions in the polymer composite molded body 1. Alternatively, the concentration or density of the fibers 14 and the fiber cloths 15 in the polymer composite 1 may be adjusted such that each property in one direction is different from that in other direction in the polymer composite molded body 1 according to its application.

The polymer composite molded body 1 of the present invention can be used for any applications that require an anisotropic feature in the mechanical properties such as coefficient of elasticity and strength, thermal properties, such as coefficient of thermal expansion and thermal conductivity, electrical properties, and/or optical properties. For example, the polymer composite molded body 1 may be applied for machine parts, mechanical parts, automobile parts, electrical products, housings for electrical or automobile products, substrates, and transmitting belts.

Referring to the plate-like polymer composite molded body 1 illustrated in FIGS. 2A to 2C as one embodiment of the present invention, the polymer composite molded body of the present invention will be described.

As shown the FIG. 2A, the cavity 11a of the molding die 11 corresponds to a desired shape for the polymer composite molded body 1 to be obtained. At least one sheet of the fiber cloth 15 (two sheets in FIGS. 2A to 2C) is disposed in the cavity 11a parallel to the surface of the polymer composite molded body 1 to be obtained. Then, the polymer composition 16 in which the fibers 14 is compounded into the polymer matrix 13 is injected into the cavity 11a and is impregnated into the fiber cloths 15. The polymer composition 16 impregnated into the fiber cloths 15 is applied with a magnetic field in the thickness direction of the composition material 1, thereby orienting the fibers 14 in the thickness direction of the polymer composite molded body 1, namely, in the direction perpendicular to planes of the fiber cloths 15. After that, the polymer composition 16 impregnated into the fiber cloths 15 is cured or solidified, and is removed from the molding die 11 to obtain the polymer composite molded body 1 having the desired shape.

Each process will be further described in detail below.

The polymer composition 16 may be prepared by compounding the fibers 14 into the polymer matrix 13 using any conventional mixing and kneading machines, such as a blender, a mixer, a roll, and extruder. It is preferable to add an additional process of compression or decompression to remove any bubbles possibly mixed into the polymer composition 16 during compounding the fibers 14.

The amount of the fibers 14 in the polymer composition 16 is not particularly specified, and may be suitably selected according to the required performance for the objective final products. The amount of the fibers 14 is preferably 0.01 to 50 parts by weight relative to 100 parts by weight of the polymer matrix 13. The larger amount of the fibers 14 improves the anisotropic properties (properties relating to the anisotropy) of the polymer composite molded body 1 to be obtained better. However, an excessive amount of the fibers 14 more than 50 parts by weight may raise the viscosity of the polymer composition 16 undesirably, causing a poor fluidity of the polymer composition 16. This results in some difficulties for controlling the orientation of the fibers 14. When the amount of the fibers 14 is less than 0.01 parts by weight, the improvement effects for the properties of the polymer composite molded body 1 to be obtained may be insufficient. The amount of the fibers 14 is more preferably 0.02 to 30 parts by weight, yet more preferably 0.05 to 20 parts by weight relative to 100 parts by weight of the polymer matrix 13.

The polymer composition 16 further includes a small amount of additives including other fillers, plasticizers, crosslinking agents, colorants, stabilizers, and solvents.

To improve the adhesion or wetability of the fibers against the polymer matrix, the surfaces of the fibers 14 and the fiber cloth 15 may be preferably subjected to a degreasing or cleaning treatments; an activating treatment such as ultraviolet irradiation, corona discharge treatment, plasma treatment, flame treatment, or ion implantation; or surface treatments using a conventional coupling agents such as silane type, titanium type, or aluminum type coupling agents, or a resorcin formalin latex. These treatments can facilitate to compound and disperse a larger amount of the fibers 14 into the polymer matrix 13.

An addition of volatile organic solvents or reactive plasticizers into the polymer composition 16 may reduce the viscosity of the composition 16 to increase the content of the fibers 14, or may reduce the difference between the specific gravities of the fiber 14 and the polymer matrix 13, thereby preventing the sedimentation of the fibers 14 and facilitating the orientation of the fibers 14 in the polymer composition 16.

At least one sheet of the fiber cloth 15 is disposed in the cavity 11a of the molding die 11 for molding the polymer composite molded body 1 such that the fiber cloths 15 are aligned parallel to the surface of the polymer composite molded body 1. At this time, the fiber cloths 15 may be secured within the cavity 11a by a fixing means such as pins to restrict the movement of the fiber cloths 15 in the cavity 11a. Then, the fiber cloths 15 are impregnated with the polymer composition 16 in which the fibers 14 are compounded into the polymer matrix 13. Prior to the impregnation, a plurality of sheets of the fiber cloth 15 may be disposed into the cavity 11a in stacked manner. Alternatively, the polymer composition may be impregnated into a sheet of the fiber cloth 15 that has been disposed into the cavity 11a firstly, then another sheet of the fiber cloth 15 is stacked onto the previous sheet followed by further impregnation with the polymer composition 16. By repeating these processes, the polymer composition 16 can be impregnated into the plurality sheets of the fiber cloth 15 to obtain the polymer composite molded body 1. During the impregnation of the polymer composition 16, it is preferable to add an additional process to remove any bubbles possibly mixed into the polymer composition 16 by compressing or decompressing the composition 16.

The fibers 14 in the polymer composition 16 can be magnetized and oriented by an external magnetic field such that their fiber axes are aligned parallel to the magnetic force lines. This results in the fibers 14 oriented in certain direction in the polymer composite molded body 1. According to the method as described above, it is possible to facilitate to produce the high performance polymer composite molded body utilizing the anisotropic characteristics such as high elasticity and low thermal expansion properties of the fibers 14 in the fiber axis direction. Such polymer composite molded body 1 may have anisotropic features such as mechanical properties including coefficient of elasticity and strength, thermal properties, optical properties, and electric properties.

More particularly, for molding a plate-like polymer composite molded body 1, when the fibers 14 having a positive value of the anisotropic diamagnetic susceptibility are oriented in the thickness direction of the plate-like polymer composite molded body, a pair of magnets 12 having a N polar and S polar respectively (ex. permanent magnet or electromagnet) as a magnetic field generating device may be disposed interposing the cavity 11a there between wherein with the N polar magnet and S polar magnet are opposed each other as shown in FIG. 2(C). In this manner, by exerting the magnetic field wherein the magnetic field lines passing through the polymer composition 16 in the thickness direction of the polymer composite molded body 1 to be obtained, the fibers 14 in the polymer composition 16 can be oriented in said thickness direction. Then, the polymer composition 16 with the fibers 14 oriented is cured or solidified to produce the polymer composite molded body 1 compounded with the fibers 14 in its thickness direction.

The magnetic field generating device 12 is not particularly specified, a permanent magnet, an electromagnet, and a coil may be suitably used. The flux density indicating the strength of the magnetic field is also not specified, however, if the flux density is in the range of 0.1 to 30 tesla (T), the orientation of the fibers 14 can be accomplished practically and efficiently. Since the fibers 14 are oriented in a direction by utilizing its anisotropic diamagnetic susceptibility χₐ, which is weak in general, the larger flux density is preferred. Therefore, the flux density may be more preferably 0.5 T or more, yet more preferably 2 T or more.

The magnetic force lines do not need to be linear, and may direct along curved lines or in several different directions. The magnetic field generating device 12 may be configured such that only a part of the polymer composition can be subjected to the magnetic field. In magnets as the magnetic field generating device 12, it is not necessary to dispose both of the N polar and S polar magnets on the both sides the polymer composition 16 in the molding die 11 and opposing each other. One magnet disposed at one side of the objective polymer composition 16 can orient the fibers 14 in the polymer composition 16 in a direction. Furthermore, vibrating of the polymer composition 16, or alternation of the magnetic field line direction can facilitate to orient the fibers 14 in the polymer composition 16.

The method for molding the polymer composite molded body 1 is not particularly specified and may utilize a extrusion molding, an injection molding, a compression molding, a transfer molding, a vacuum molding, and a rotational molding processes.

The advantages in the embodiments described above are listed below.

In the polymer composite molded body 1 in which the fibers 14 and at least one sheet of the fiber cloth 15 are compounded into the polymer matrix 13, the fibers 14 are oriented, preferably substantially perpendicularly, crossing with the fiber cloths 15. This provides the high performance polymer composite molded body having the improved properties in three-dimensional directions thereof utilizing the excellent various properties of the fibers in their fiber axes such as high elasticity, high strength, and high heat resistance.

The length of the fiber 14 less than 10 mm allows the fibers 14 to be dispersed uniformly in the polymer matrix 13, resulting in a good moldability of the polymer composition 16 and easy control for orienting the fibers 14 in the polymer composition 16.

It should be apparent to those skilled in the art that the present invention may be embodied in many other specific forms without departing from the spirit or scope of the invention. Particularly, it should be understood that the invention may be embodied in the following forms.

The above descriptions mainly relates to the plate-like polymer composite molded body 1, however, a shape of the polymer composite molded body 1 is not particularly specified, and may be a cubic, a spherical, a cylindrical, a plate-like, a film-like, a bar, and a tubular shapes.

In the polymer composite molded body 1, it is desirable that the fibers 14 are oriented in a direction substantially perpendicular to a plane of the fiber cloth 15. However, the fibers 14 may be oriented in any one direction crossing with the plane of the fiber cloth 15 depending to the shape of the polymer composite molded body 1.

Furthermore, the fibers 14 may be oriented in a direction within a part of the polymer composite molded body 1 and/or the fiber cloth 15 may be compounded in a part of the polymer composite molded body 1.

### EXAMPLES

Next, the embodiments will be described in more detail with reference to the following Examples and a Comparative Example. These Examples and Comparative Examples are not intended to specify the scope of the present invention.

### Example 1

The 100 parts by weight of unsaturated polyester resin (EPOLAK G157 manufactured by NIPPON SHOKUBAI CO., Ltd) as the polymer matrix 13 and the 25 parts by weight of the carbon fibers 14 (Melblon Milled fiber (diameter: 8 μm, length: 25 μm), manufactured by PETOCA MATERIALS LIMITED) were mixed and then deaerated under the vacuum to prepare the polymer composition 16.

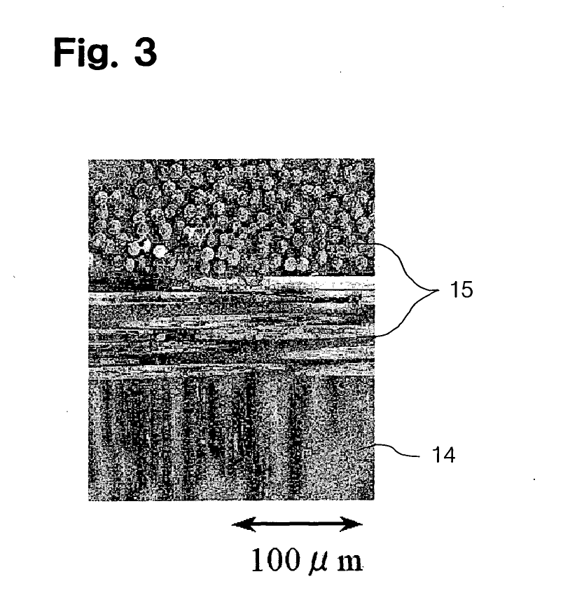

As shown FIGS. 2A to C, one sheet of the carbon fiber cloth 15 (Granoc Fabric PF-XN05-130 (weight per a unit area (reffered to “METSUKE”): 130 g/cm², weaving density: 8 yarns/cm, fiber diameter: 10 μm) was placed into the fluoric resin-coated cavity 11a of the molding die 11 made of aluminum in parallel to the surface of the polymer composite molded body 1 to be obtained (FIG. 2A). The prepared polymer composition 16 was poured into the cavity 11a to allow the polymer composition 16 to be impregnated into the carbon fiber cloth 15 (FIG. 2B). Subsequently, another sheet of the carbon fiber cloth 15 was placed onto the previous carbon cloth 15 in the cavity 11a to be impregnated with the polymer composition 16. Then, the fibers 14 were oriented sufficiently in the direction substantially perpendicular to the plane of the carbon fiber cloth 15 by the magnetic field with the flux density of 8 (T). The magnetic field was generated by the magnets 12 arranged interposing the cavity 11a therebetween, wherein the N polar magnet and S polar magnet were opposed each other (FIG. 2C). After that, the polymer composition 16 was solidified by heating to obtain the plate-like polymer composite molded body 1. FIG. 3 is an electron microscopic photograph of a cross-section of the resultant polymer composite molded body 1. As shown FIG. 3, two carbon fiber cloths 15 are aligned parallel to the surface of the polymer composite molded body 1 of Example 1 and the carbon fibers 14 are oriented in the direction perpendicular to the plane of the carbon fiber cloths 15.

Table 1 shows the linear expansion coefficients of the resultant polymer composite molded body 1 that were measured according to JIS K7197 (JIS: Japanese Industrial Standard) Each linear expansion coefficient was measured by using a test sample (5 mm(W)×5 mm(L)×5 mm(T)) formed by cutting the resultant polymer composite molded body 1. In the plate-like polymer composite molded body 1 of Example 1, its linear expansion coefficients were 7.99×10⁻⁵/° C. in Z direction perpendicular to the plane of the plate-like polymer composite molded body 1, and 6.81×10⁻⁵/° C. in X direction parallel to the plane of the plate-like polymer composite molded body 1.

### Examples 2 and 3

Each of Polymer composite molded body 1 was produced in the same manner as Example 1 except being the amount of the carbon fiber 14 in the polymer composition 16 as shown Table 1 respectively. In each of the resultant polymer composite molded body 1, the carbon fibers 14 were oriented in the direction perpendicular to the plane of the fiber cloths 15 as observed in Example 1.

Table 1 also shows the measurements of the linear expansion coefficients of the polymer composite molded bodies of Example 2 and 3. The measurements were measured in the same manner as Example 1. In the Polymer composite molded bodies 1 of Example 2 compounded 50 parts by weight of carbon fiber 14, its linear expansion coefficients were 2.76×10⁻⁵/° C. in Z direction, and 6.45×10⁻⁵/° C. in X direction of the plate-like polymer composite molded body 1. In the Polymer composite molded body 1 of Example 3 compounded with 100 parts by weight of carbon fiber 14, its linear expansion coefficients were 3.64×10⁻⁶/° C. in Z direction, and 6.07×10⁻⁵/° C. in X direction of the plate-like polymer composite molded body 1.

### Comparative Example 1

As Comparative Example, the plate like polymer composite molded body were produced in the same manner except using a polymer composition comprising the unsaturated polyester resin (EPOLAK G157 manufactured by NIPPON SHOKUBAI CO., Ltd) as the polymer matrix but no carbon fiber 14, instead of the polymer composition 16 in Example 1 to 3. The linear expansion coefficients of Comparative Example 1 were measured in the same manner as the previous Examples and also shown in Table 1. In this polymer composite molded body, its linear expansion coefficients were 1.12×10⁻⁴/° C. in Z direction, and 6.22×10⁻⁵/° C. in X direction of the plate-like polymer composite molded body.

TABLE 1

| | | | | Comp. |
|---|---|---|---|---|
| | Ex. 1 | Ex. 2 | Ex. 3 | Ex. 1 |
| Amount of | 25 | 50 | 100 | 0 |
| carbon fiber 14 | | | | |
| (parts by | | | | |
| weight) | | | | |
| Linear | 6.81 × 10⁻⁵ | 6.45 × 10⁻⁵ | 6.07 × 10⁻⁵ | 6.22 × 10⁻⁵ |
| expansion | | | | |
| coefficient in X | | | | |
| direction | | | | |
| (/° C.) | | | | |
| Linear | 7.27 × 10⁻⁵ | 7.42 × 10⁻⁵ | 5.47 × 10⁻⁵ | 6.50 × 10⁻⁵ |
| expansion | | | | |
| coefficient in Y | | | | |
| direction | | | | |
| (/° C.) | | | | |
| Linear | 7.99 × 10⁻⁵ | 2.76 × 10⁻⁵ | 3.64 × 10⁻⁶ | 1.12 × 10⁻⁴ |
| expansion | | | | |
| coefficient in Z | | | | |
| direction | | | | |
| (/° C.) | | | | |

In each of the polymer composite molded body 1 obtained in Example 1 to 3 according to the present invention, the carbon fiber cloths 15 are disposed such that the plane of the cloth 15 extends to the direction parallel to the surface of the polymer composite molded body 1, namely, X direction and Y direction, while the carbon fibers 14 are oriented such that their fiber axes are aligned to the direction substantially perpendicular to the plane of each carbon fiber cloth 15, thus substantially perpendicular to the surface of the polymer composite molded body 1, namely the Z direction. Accordingly, their linear expansion coefficients in X direction and Y direction have been reduced, while their linear expansion coefficients in X direction have been reduced smaller as larger amount of the carbon fiber 14 was compounded into the polymer composition. Thus, it is recognized that the expansion of the polymer composite molded body 1 have been reduced in all of X, Y, and Z directions thereof.

On the other hand, the polymer composite molded body obtained in Comparative Example 1 comprises the unsaturated polyester resin and the carbon fiber cloth 15 only. In this polymer composite molded body, it is recognized that the expansion in X and Y directions have been reduced, but the expansion in Z direction was not reduced.

Therefore, the present examples and embodiments are to be considered as illustrative and not restrictive and the invention is not to be limited to the details given herein, but may be modified within the scope and equivalence of the appended claims.

1. A polymer composite molded body having a surface, comprising:
a polymer matrix;
at least one sheet of a fiber cloth disposed in the polymer matrix, wherein the fiber cloth is oriented along the surface of the polymer composite molded body; and
fibers disposed in the polymer matrix, wherein the fibers are oriented in a direction crossing with the fiber cloth.

2. The polymer composite molded body of claim 1, wherein the fibers are oriented in a direction substantially perpendicular to each of the fiber cloth.

3. The polymer composite molded body of claim 1, wherein the fibers are oriented by a magnetic field.

4. The polymer composite molded body of claim 1, wherein the fibers have an anisotropic diamagnetic susceptibility of 1×10⁻⁹ emu/g or more.

5. The polymer composite molded body of claim 1, wherein the fibers have a length of 10 mm or less.

6. The polymer composite molded body of claim 1, wherein the fibers and the fiber cloth independently comprise at least one selected from carbon fibers, metal fibers, glass fibers, ceramic fibers, and organic fibers.

7. A method for producing a polymer composite molded body having a surface and containing fibers and at least one sheet of a fiber cloth in a polymer matrix, the method comprising steps of:
preparing a molding die having a cavity with a shape corresponding to the polymer composite molded body to be produced;
disposing the fiber cloth in the cavity such that the fiber cloth is aligned along the surface of the polymer composite molded body;
filling the cavity with a polymer composition containing the fibers and the polymer matrix, thereby impregnating the polymer composition into each fiber cloth;
applying a magnetic field to the polymer composition impregnated in the fiber cloth to orient the fibers in the polymer composition such that the fibers are oriented in a direction crossing with the fiber cloth; and
solidifying the polymer composition with the fibers being oriented therein.

8. The method of claim 7, further comprising a step of securing the fiber cloth within the cavity, after the step of disposing the fiber cloth in the cavity.

9. The method of claim 7, further comprising a step of removing bubbles in the polymer composition by either of compressing and decompressing, after the step of impregnating the polymer composition into the fiber cloth.

10. The method of claim 7, wherein the fibers are oriented in a direction substantially perpendicular to the fiber cloth.

11. The method of claim 7, wherein the magnetic field is applied by either of a permanent magnet and an electromagnet.

12. The method of claim 7, wherein a flux density in the magnetic field is in the range of from 0.1 to 30 tesla.
